(19) United States
(12) Patent Application Publication
(10) Pub. No.: US 2020/0386571 A1
(43) Pub. Date: Dec. 10, 2020

(54) VEHICLE CONTROL SYSTEM AND VEHICLE CONTROL PROGRAM

(71) Applicant: AISIN AW CO., LTD., Anjo-shi, Aichi-ken (JP)

(72) Inventors: Morihiro HIRATE, Okazaki (JP); Sadahiro KOSHIBA, Okazaki (JP)

(73) Assignee: AISIN AW CO., LTD., Anjo-shi, Aichi-ken (JP)

(21) Appl. No.: 16/772,466

(22) PCT Filed: Dec. 19, 2018
(86) PCT No.: PCT/JP2018/046737

§ 371 Date: Jun. 12, 2020

(30) Foreign Application Priority Data
Dec. 27, 2017 (JP) 2017-250947

(51) Int. Cl. G01C 21/36; G05D 1/02

(52) U.S. Cl. CPC G01C 21/3658; G05D 1/0219

(57) ABSTRACT

A vehicle control system and program obtain a planned travel route of a vehicle; obtain a recommended lane on which the vehicle is to travel, based on the planned travel route; obtain a recommended region that the vehicle is to travel in an intersection included in the planned travel route, based on the planned travel route; control the vehicle to travel along the recommended lane when a distance between the vehicle and the intersection is greater than or equal to a threshold value; and control the vehicle to travel the recommended region at the intersection when the distance between the vehicle and the intersection is less than the threshold value

### TECHNICAL FIELD

The present disclosure relates to a vehicle control system and a vehicle control program.

### BACKGROUND ART

Conventionally, there is known a technique for performing control to automatically drive a vehicle. For example, Patent Literature 1 discloses a technique in which a travel course passing through near the center of a lane on a road included in a planned travel route is set, reference points are set on the travel course at predetermined spacings, and vehicle control is performed based on the reference points.

### CITATIONS LIST

### Patent Literature

Patent Literature 1: JP 2017-117079 A

### SUMMARY

### Technical Problems

In the conventional technique, there has been a very large amount of information that is to be prepared for vehicle control. Namely, to set a travel course at the center of a lane, various information such as the shape of a road, the width of the lane, the number of lanes, a merging section, and a road structure needs to be referred to. These pieces of information need to be prepared in advance for all roads that can serve as a planned travel route. However, it is very difficult to prepare in advance detailed information for all roads that can serve as a planned travel route.

The present disclosure is made in view of the above-described problem, and provides a technique for increasing the possibility of being able to implement self-driving using information that can be easily prepared.

### Solutions to Problems

To provide the above-described technique, a vehicle control system includes: a planned travel route obtaining part that obtains a planned travel route of a vehicle; a recommended lane obtaining part that obtains a recommended lane on which the vehicle is to travel, based on the planned travel route; a recommended region obtaining part that obtains a recommended region that the vehicle is to travel in an intersection included in the planned travel route, based on the planned travel route; and a vehicle control part that controls the vehicle to travel along the recommended lane when a distance between the vehicle and the intersection is greater than or equal to a threshold value, and controls the vehicle to travel the recommended region at the intersection when the distance between the vehicle and the intersection is less than the threshold value.

In addition, to provide the above-described technique, a vehicle control program causes a computer to function as: a planned travel route obtaining part that obtains a planned travel route of a vehicle; a recommended lane obtaining part that obtains a recommended lane on which the vehicle is to travel, based on the planned travel route; a recommended region obtaining part that obtains a recommended region that the vehicle is to travel in an intersection included in the planned travel route, based on the planned travel route; and a vehicle control part that controls the vehicle to travel along the recommended lane when a distance between the vehicle and the intersection is greater than or equal to a threshold value, and controls the vehicle to travel the recommended region at the intersection when the distance between the vehicle and the intersection is less than the threshold value.

Namely, in the vehicle control system and the vehicle control program, the vehicle is controlled based on different pieces of information for when a distance to an intersection is greater than or equal to the threshold value and when the distance to the intersection is less than the threshold value (i.e., when the vehicle is far from the intersection and when the vehicle is near the intersection). Then, when the vehicle is far from the intersection, the vehicle is controlled to travel along a recommended lane, and when the vehicle is near the intersection, the vehicle is controlled to travel a recommended region at the intersection.

When the vehicle is controlled to travel along the recommended lane, it is not necessary to prepare in advance detailed information, e.g., information that can accurately identify a center location of a lane (the location (latitude/longitude) of the center of a lane measured by a measuring vehicle, etc.). This is because if a recommended lane is found, then it is possible to allow the vehicle to travel on the recommended lane by, for example, monitoring section lines of the lane.

On the other hand, since there are no lanes at intersections, in order to allow the vehicle to automatically travel in the intersections, accurate information has been conventionally required for each intersection. The accurate information is, for example, information indicating courses along which the vehicle is to travel in an intersection, and obtained by accurately measuring in advance the courses for all lanes. However, if it is configured to be able to obtain a recommended region that the vehicle is to travel, then it is easy to control the vehicle to travel in the region, and it is possible to allow the vehicle to automatically travel through an intersection even if courses taken upon traveling through the intersection have not been accurately measured in advance for all lanes.

According to the above-described configuration, if vehicle's courses have not been accurately measured at an intersection and a recommended region that specifies an area in which the vehicle can travel in a wider area can be obtained, then the vehicle can be controlled at the intersection, and it is possible to increase the possibility of being able to implement self-driving using information that can be easily prepared, over a configuration in which vehicle's courses are accurately measured. In addition, there is no need to prepare detailed information for all roads other than intersections to implement control performed at a portion far from an intersection. Therefore, it is possible to increase the possibility of being able to implement self-driving using information that can be easily prepared, over a configuration in which detailed information is prepared for all roads other than intersections.

Furthermore, to provide the above-described technique, a vehicle control system may be configured to include: a planned travel route obtaining part that obtains a planned travel route of a vehicle; a recommended region obtaining part that obtains a recommended region that the vehicle is to travel in an intersection included in the planned travel route, based on the planned travel route; and a vehicle control part that controls the vehicle to travel the recommended region at the intersection.

Furthermore, to provide the above-described technique, a vehicle control program may be configured to cause a computer to function as: a planned travel route obtaining part that obtains a planned travel route of a vehicle; a recommended region obtaining part that obtains a recommended region that the vehicle is to travel in an intersection included in the planned travel route, based on the planned travel route; and a vehicle control part that controls the vehicle to travel the recommended region at the intersection.

Namely, in the vehicle control system and the vehicle control program, a recommended region that the vehicle is to travel in an intersection is obtained, and the vehicle is controlled to travel the recommended region. Intersections have high arbitrariness of a shape, etc., over sections other than the intersections, and thus, vehicle behavior needs to be controlled in accordance with the intersections. For example, the shape of an intersection or a region that the vehicle can travel at the intersection variously changes depending on the angle of intersection of a road and the intersection, the number of lanes that can enter the intersection, the number of lanes that can exit from the intersection, etc. Therefore, at an intersection, vehicle behavior needs to be controlled according to the arbitrariness of the intersection.

However, sections other than intersections have a relatively simple structure in which lanes extend in a direction of a road, and though the number of lanes, etc., can change, vehicle behavior is simple. Therefore, the vehicle can be controlled without preparing a large amount of information. Hence, the vehicle control system and the vehicle control program are configured to be able to obtain, at least at an intersection, a recommended region serving as a target for controlling vehicle behavior in the intersection.

Namely, since generally there are no lanes in intersections, in order to allow the vehicle to automatically travel in the intersections, detailed information has been conventionally required for each intersection. The detailed information is, for example, information indicating courses along which the vehicle is to travel in an intersection, and obtained by accurately measuring in advance the courses for all lanes. However, if it is configured to be able to obtain a recommended region that the vehicle is to travel, then it is easy to control the vehicle to travel in the region, and it is possible to allow the vehicle to automatically travel through an intersection even if courses taken upon traveling through the intersection have not been accurately measured in advance for all lanes. Therefore, according to the above-described configuration, it is possible to increase the possibility of being able to implement self-driving using information that can be easily prepared.

### BRIEF DESCRIPTION OF DRAWINGS

FIG. 1 is a block diagram of a navigation system.

FIG. 2A is a diagram showing an example of an intersection and FIG. 2B is a diagram showing an example of navigation map information.

FIGS. 3A to 3L are diagrams showing examples of recommended regions.

FIG. 4 is a flowchart of a vehicle control process.

### DESCRIPTION OF EMBODIMENTS

Here, embodiments of the present disclosure will be described in the following order:

(1) Configuration of a navigation system;

(2) Vehicle control process; and

(3) Other embodiments.

### (1) Configuration of a Navigation System

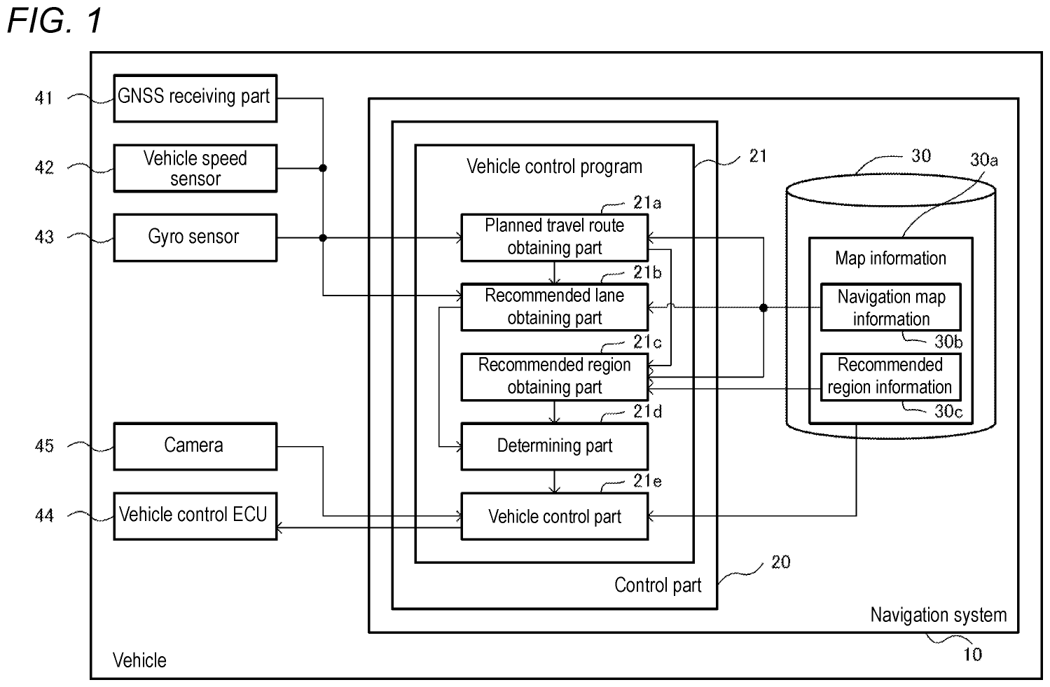

FIG. 1 is a block diagram showing a configuration of a navigation system 10 including a vehicle control system according to one embodiment of the present disclosure. The navigation system 10 is provided in a vehicle and includes a control part 20 including a CPU, a RAM, a ROM, etc., and a recording medium 30. The navigation system 10 can execute programs stored in the recording medium 30 or the ROM, by the control part 20. The recording medium 30 has map information 30a recorded therein in advance.

The map information 30a includes navigation map information 30b used for route guidance and vehicle control; and recommended region information 30c used for vehicle control. The navigation map information 30b is information used, for example, to identify a vehicle location and a facility which is a guidance target and identify a recommended lane, and includes node data representing the locations of nodes set on roads on which the vehicle travels, etc.; shape interpolation point data representing the locations of shape interpolation points for identifying the shapes of roads between nodes, etc.; link data representing links between nodes; data representing the locations of ground objects present on roads or around the roads; and the like.

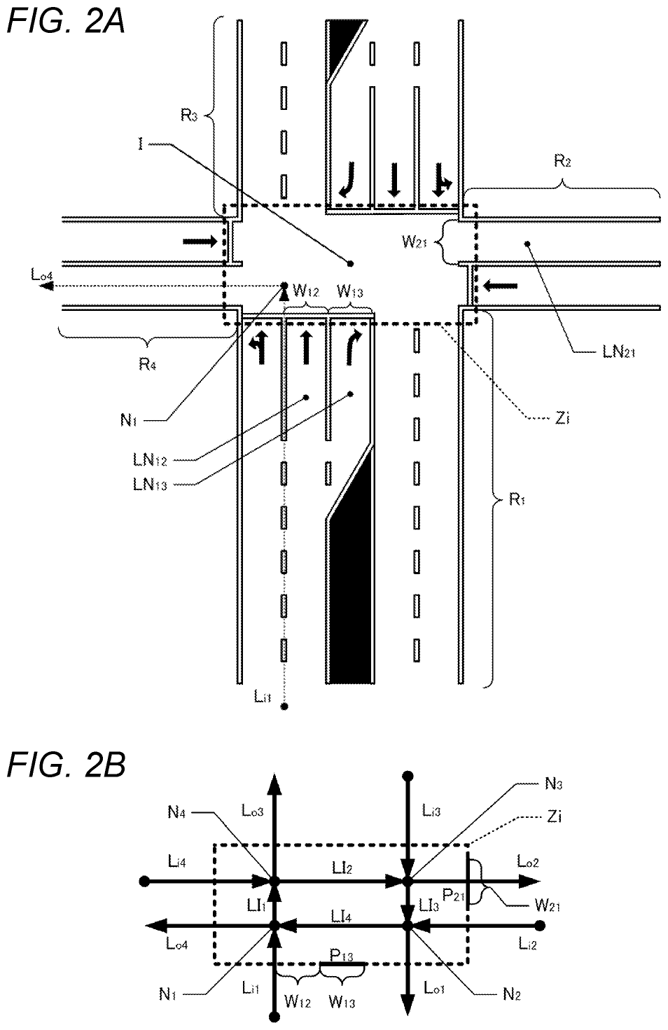

In addition, in the present embodiment, the link data is defined for each traveling direction of the vehicle on a road section, and is associated with the traveling direction. Hence, for a two-way traffic road, one link is defined for each direction. FIG. 2A is a diagram schematically showing a map of an area around an intersection, and FIG. 2B is a diagram schematically showing link data representing road sections connected to the intersection.

To an intersection I shown in FIG. 2A are connected four road sections R₁ to R₄. Each of the road sections R₁ to R₄ is a two-way road. Therefore, link data representing the road sections in their respective directions is defined as navigation map information 30b. FIG. 2B shows link data that is extracted from an area near an intersection region Zi indicating the intersection I.

As shown in FIG. 2B, in connection with the intersection region Zi, links Lᵢ₁ to Lᵢ₄ indicating road sections that enter the intersection I from the road sections R₁ to R₄, respectively, are defined, and nodes N₁ to N₄ are set at end points of the links Lᵢ₁ to Lᵢ₄. In addition, links Lₒ₁ to Lₒ₄ indicating road sections that exit onto the road sections R₁ to R₄, respectively, from the intersection are defined. The links Lₒ₁ to Lₒ₄ are links having the nodes N₁ to N₄ in the intersection as their end points. In addition, in the present embodiment, links LI₁ to LI₄ based on traveling directions are also formed between the nodes N₁ to N₄. For example, in order to show an allowance for travel in a direction from the link Lᵢ₁ indicating the road section R₁ to the link Lₒ₃ indicating the road section R₃, the link LI₁ directed from the node N₁ to the node N₄ is defined.

Note that, in the present embodiment, an end point of each link is a node and a location is defined by node data, and thus, the location of a road indicated by a link is also indicated by a node. In the present embodiment, a node is defined so as to be located at the center of a road section represented by link data. Therefore, when the number of lanes for each traveling direction is one (e.g., the road sections R₂ and R₄ in FIG. 2A), a link is set so as to pass through the center of a lane. When the number of lanes for each traveling direction is two or more (e.g., the road sections R₁ and R₃ in FIG. 2A), a link is disposed at the center of a road including a plurality of lanes.

Note, however, that for a road section whose lane configuration changes in a section other than just before the intersection from a lane configuration obtained just before the intersection (e.g., the road section indicated by the link Lᵢ₁ in FIGS. 2A and 2B), a link is disposed at the center of a road in the section other than just before the intersection. Note that in FIG. 2A parts of links, etc., shown in FIG. 2B (the links Lᵢ₁ and Lₒ₄ and the node N₁) are extracted and represented by a thin dotted line. The above-described configuration is, of course, an example and the locations of nodes, etc., may be set at other references, e.g., the center of the intersection.

Furthermore, in the present embodiment, lane data is associated with link data. The lane data is information indicating a lane(s) present on a road, and includes information indicating the number of lanes present on the road and the width of the lanes. In addition, when a lane configuration changes on a road section represented by link data, lane data includes information indicating each lane configuration. For example, for a road section in which the number of lanes is two in a section other than just before an intersection, but the number of lanes is increased to three just before the intersection, information indicating a location where the number of lanes changes from two to three and the numbers of lanes before and after the change is included in lane data.

In addition, lane data is associated with traveling directions that can be selected for each lane. For example, when given link data represents an entry road to a given node, and there are three lanes on the entry road to an intersection where the given node is present, and a left lane, a center lane, and a right lane allow straight ahead and a left turn, straight ahead, and a right turn, respectively, information indicating those is included in lane data.

The navigation map information 30b may include various types of information other than the above-described information. For example, information indicating speed limit on road sections, information indicating painting on roads (information indicating the types, locations, etc., of painting, etc.), information indicating the locations of lanes, etc., may be included. Note that information indicating the locations of roads, painting, lanes, etc., may be absolute locations (latitude/longitude, etc.) or may be relative locations (relative distances, directions, etc., from a reference) or may be both.

The recommended region information 30c is information indicating recommended regions that the vehicle is to travel in an intersection. In the present embodiment, recommended regions are associated with an intersection region Zi of each intersection indicated by the navigation map information 30b. Namely, in the navigation map information 30b, the location of an intersection is defined by a node in the intersection, and thus, an intersection region Zi is defined so as to be associated with the location of the intersection. Then, recommended regions are defined so as to be associated with the intersection region Zi, forming recommended region information 30c.

In the present embodiment, recommended regions are defined for all combinations of traveling directions that can be adopted at an intersection. Namely, recommended regions are defined for each combination of an entry road to the intersection and an exit road from the intersection. In addition, a recommended region indicates a portion of the intersection where the vehicle is allowed to travel, and is defined as a portion having a finite area, but not as a linear portion.

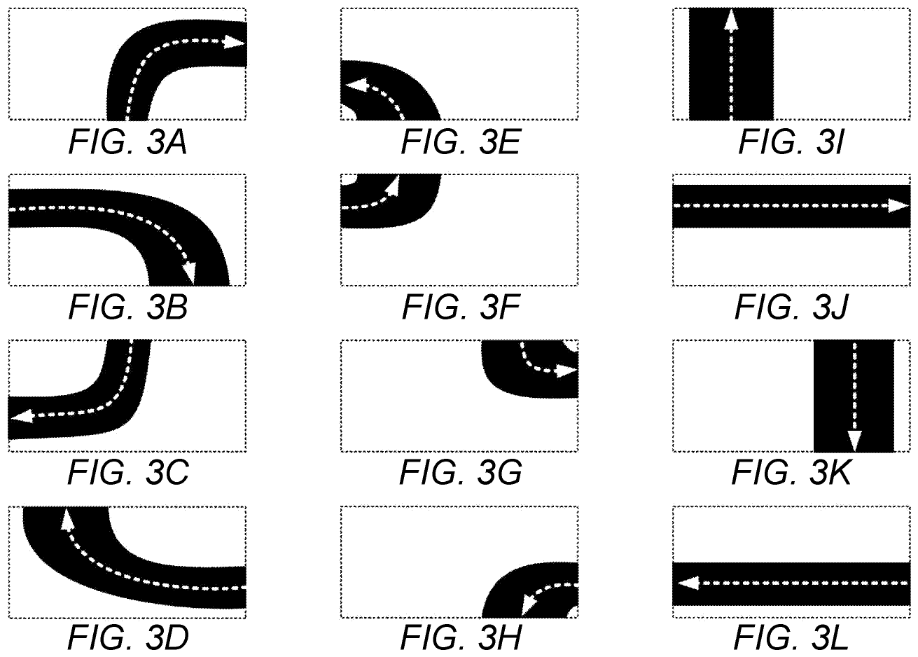

FIGS. 3A to 3L show recommended regions associated with the intersection region Zi of the intersection I shown in FIGS. 2A and 2B. In FIGS. 3A to 3L, the recommended regions are colored in black and the intersection region Zi is represented by a dotted-line rectangle. FIGS. 3A to 3D are recommended regions for when the vehicle makes a right turn at the intersection, FIGS. 3E to 3H are recommended regions for when the vehicle makes a left turn at the intersection, and FIGS. 31 to 3L are recommended regions for when the vehicle travels straight ahead at the intersection.

For example, FIG. 3A shows that an entry road to the intersection I is the road section R₁, and an exit road from the intersection I is the road section R₂. Namely, a recommended region that the vehicle is to travel at the intersection I when traveling from a lane LN₁₃ to a lane LN₂₁ which are shown in FIG. 2A is a portion colored in black which is shown in FIG. 3A. Hence, in this example, the road section R₁ is associated as an entry road with the region shown in FIG. 3A and the road section R₂ is associated as an exit road with the region shown in FIG. 3A, forming a part of recommended region information 30c for the intersection I. In FIGS. 3A to 3L, a traveling direction of the vehicle in a recommended region is represented by a dashed white arrow.

Note that the recommended region information 30c may adopt various modes, and information indicating, for each location in the intersection region Zi, whether it is a recommended region such as image data may be defined, or information indicating at least a part of a boundary of a recommended region by, for example, information indicating a plurality of points or a curve connecting points such as vector data may be defined. Furthermore, the recommended region information 30c may be configured in any manner as long as recommended region information 30c for an intersection can be obtained at least before allowing the vehicle to perform self-driving at the intersection.

Therefore, recommended region information 30c may be generated in advance and recorded in the recording medium 30, or after the vehicle starts traveling, recommended region information 30c may be generated before the vehicle reaches an intersection, and recorded in the recording medium 30. Of course, recommended region information 30c may be generated by an external server, etc., and obtained by the navigation system 10 through communication. In the present embodiment, a configuration is adopted in which when the vehicle approaches an intersection, recommended region information 30c is generated based on the navigation map information 30b. Of course, regeneration of recommended region information 30c having been generated once may be omitted, and when the navigation map information 30b is updated, recommended region information 30c may be regenerated for an updated intersection.

The vehicle of the present embodiment includes a GNSS receiving part 41, a vehicle speed sensor 42, a gyro sensor 43, a vehicle control ECU 44, and a camera 45. The GNSS receiving part 41 is a device that receives Global Navigation Satellite System signals, and receives radio waves from navigation satellites and outputs a signal for calculating a current location of the vehicle through an interface which is not shown. The control part 20 obtains the signal and thereby obtains a current location of the vehicle. The vehicle speed sensor 42 outputs a signal corresponding to the rotational speed of wheels included in the vehicle. The control part 20 obtains the signal through an interface which is not shown, and thereby obtains vehicle speed. The gyro sensor 43 detects angular acceleration of the vehicle for a turn in a horizontal plane, and outputs a signal corresponding to the orientation of the vehicle. The control part 20 obtains the signal and thereby obtains a traveling direction of the vehicle. The vehicle speed sensor 42, the gyro sensor 43, and the like, are used to identify a travel path of the vehicle. In the present embodiment, a current location is identified based on the point of departure and travel path of the vehicle, and the current location of the vehicle identified based on the point of departure and the travel path is corrected based on the output signal from the GNSS receiving part 41.

The vehicle control ECU 44 is an electronic control unit (ECU) for controlling vehicle behavior. The vehicle control ECU 44 obtains the amount of control from the control part 20, and controls a control target with the amount of control. The control target may be various devices and includes, for example, a steering, an engine (a throttle, etc.), a motor, a brake, and a transmission which are not shown. Of course, to identify the amount of control, other sensors, e.g., a millimeter-wave radar or a laser radar, may be provided, and a configuration in which the amount of control that differs from the amount of control outputted from the control part 20 is added as appropriate (e.g., avoidance of an obstacle, etc., is performed), etc., may be adopted.

The camera 45 is a camera fixed to the vehicle such that the field of view includes left and right section lines on a road on which the vehicle travels, and photographs an image in a predetermined cycle, and generates and outputs image information indicating the photographed image. The control part 20 obtains the image information outputted from the camera 45.

The control part 20 can perform a function of guiding the vehicle to a destination along a planned travel route by a function of a navigation program which is not shown. The navigation program includes various types of functions, and a vehicle control function is included in the various types of functions.

Upon performing a navigation function, the control part 20 accepts input of a destination by a driver through an input part (buttons, a touch panel, etc.) of a user I/F part which is not shown, by a function of the navigation program. In addition, the control part 20 obtains a current location of the vehicle based on output signals from the GNSS receiving part 41, the vehicle speed sensor 42, and the gyro sensor 43. Then, the control part 20 searches for a route for traveling to the destination with the current location being a point of departure, by referring to the navigation map information 30b, and obtains the route as a planned travel route.

When vehicle travel starts with the planned travel route identified, by a function of the navigation program, the control part 20 identifies a current location every certain period, based on output signals from the GNSS receiving part 41, the vehicle speed sensor 42, and the gyro sensor 43. Then, the control part 20 outputs a control signal to an output part (a display, a speaker, etc.) of the user I/F part, and provides route guidance such that the current location moves along the planned travel route. Of course, whether to provide route guidance may be determined by a user, and a configuration in which route guidance is not provided when automatic control of the vehicle is performed, etc., may be adopted.

The navigation program includes a function of allowing the vehicle to travel along a planned travel route, in addition to such a route guidance function. A function of performing vehicle control is implemented by a vehicle control program 21. In order for the vehicle control program 21 to perform the function of allowing the control part 20 to perform the function of allowing the vehicle to travel along a planned travel route, the vehicle control program 21 includes a planned travel route obtaining part 21a, a recommended lane obtaining part 21b, a recommended region obtaining part 21c, a determining part 21d, and a vehicle control part 21e.

The planned travel route obtaining part 21a is a program module that allows the control part 20 to perform a function of obtaining a vehicle's planned travel route. Namely, by a function of the planned travel route obtaining part 21a, the control part 20 accepts input of a destination by the driver through the input part of the user I/F part which is not shown. In addition, the control part 20 obtains a current location of the vehicle based on output signals from the GNSS receiving part 41, the vehicle speed sensor 42, and the gyro sensor 43. Then, the control part 20 searches for a route for traveling to the destination after departing the current location by referring to the navigation map information 30b, and obtains the route as a planned travel route.

The recommended lane obtaining part 21b is a program module that allows the control part 20 to perform a function of obtaining a recommended lane on which the vehicle is to travel, based on the planned travel route. Namely, the control part 20 identifies a traveling direction at an intersection included in the planned travel route. In addition, the control part 20 identifies a lane configuration of an entry road to the intersection by referring to lane data in the navigation map information 30b. Then, the control part 20 identifies a lane on which the vehicle is to travel upon traveling in the traveling direction at the intersection included in the planned travel route, and obtains the lane as a recommended lane.

The recommended region obtaining part 21c is a program module that allows the control part 20 to perform a function of obtaining a recommended region that the vehicle is to travel in the intersection included in the planned travel route, based on the planned travel route. Namely, the control part 20 identifies a traveling direction at the intersection included in the planned travel route, and identifies an entry road to the intersection and an exit road from the intersection, based on the navigation map information 30b. Then, the control part 20 obtains information indicating a recommended region for a combination of the entry road to the intersection and the exit road from the intersection that is associated with the intersection, by referring to the recommended region information 30c.

Note that when recommended region information 30c for the intersection has not been generated yet, the control part 20 generates recommended region information 30c for the intersection by a function of the recommended region obtaining part 21c. In the present embodiment, the control part 20 generates recommended region information 30c, based on the navigation map information 30b. Specifically, the control part 20 generates recommended region information 30c, based on link data and lane data represented by the navigation map information 30b.

Namely, the control part 20 identifies lanes for traveling the entry road to the intersection and the exit road from the intersection, based on the lane data. In addition, the control part 20 identifies parts where each lane and a side of an intersection region Zi overlap each other, based on the link data. Each part is obtained by, for example, the control part 20 identifying the width of a lane based on the lane data and calculating a part where the lane and a side of the intersection region Zi overlap each other from the width of the lane, based on the location of a road section represented by the link data.

In the example shown in FIGS. 2A and 2B, a case is assumed in which an entry road to the intersection is the road section R₁ and an exit road from the intersection is the road section R₂. In this case, a lane on which the vehicle is to travel in the road section R₁ is LN₁₃, and a lane on which the vehicle is to travel in the road section R₂ is LN₂₁. The link Lᵢ₁ is disposed at the center of a road including two lanes in a section in which the number of lanes on the road section R₁ is two. Therefore, the control part 20 sets a width W₁₃ part of the lane LN₁₃ at a location distanced by a width W₁₂ of a lane LN₁₂ from a point of intersection of the link Lᵢ₁ and a side of the intersection region Zi, and thereby identifies a part P₁₃ where the lane LN₁₃ and the side of the intersection region Zi overlap each other.

In addition, the link Lₒ₂ is disposed at the center of the road section R₂. Therefore, the control part 20 sets a width W₂₁ part of the lane LN₂₁ on a side of the intersection region Zi with a point of intersection of the link Lₒ₂ and the side of the intersection region Zi being the center, and thereby identifies a part P₂₁ where the lane LN₂₁ and the side of the intersection region Zi overlap each other. Note that in FIG. 2B the part P₁₃ and the part P₂₁ are represented by solid lines.

When parts where the lanes and the sides of the intersection region Zi overlap each other are identified, the control part 20 obtains a region that connects the parts, as a recommended region. For example, in the above-described case in FIG. 2B, the control part 20 obtains a region that connects the part P₁₃ to the part P₂₁. A process for this may be various processes, and may be implemented by, for example, identifying smooth curves (e.g., Bezier curves or clothoid curves) each connecting end points of the part P₁₃ and the part P₂₁, and obtaining a region enclosed by the curves and the part P₁₃ and the part P₂₁. As a result, for example, a recommended region shown in FIG. 3A is obtained. Note that upon identifying curves each connecting end points of the part P₁₃ and the part P₂₁, curves that connect end points on the left side in a traveling direction and connect end points on the right side in the traveling direction are identified.

The determining part 21d is a program module that allows the control part 20 to perform a function of determining whether to control the vehicle using the recommended region, based on a positional relationship between the vehicle and the intersection. Namely, in the present embodiment, in a road section other than the intersection, the control part 20 controls the vehicle to travel along the recommended lane. On the other hand, when the vehicle is present in the intersection, the vehicle is controlled to travel the recommended region. Hence, the control part 20 selects a vehicle control mode, based on a positional relationship between the vehicle and the intersection.

Specifically, when the distance between the vehicle and the intersection is greater than or equal to a threshold value, the control part 20 determines to perform control that allows the vehicle to travel along the recommended lane. In addition, when the distance between the vehicle and the intersection is less than the threshold value, the control part 20 determines to control the vehicle to travel the recommended region at the intersection. The threshold value may be any predetermined value. For example, the threshold value may be a value for determining whether the vehicle is just before entering the intersection, or may be a value for determining whether the vehicle has approached the intersection to a distance at which the vehicle is to prepare for the intersection.

In the latter case, in an area before entering the intersection, control that allows the vehicle to travel along the recommended lane may continue, or the control may be gradually switched to control performed at the intersection, and various modes can be adopted. In addition, a configuration may be adopted in which by the control part 20 connecting a target course obtained in control that allows the vehicle to travel along the recommended lane (described later) to a target course obtained upon controlling the vehicle to travel the recommended region at the intersection (described later), vehicle control continues upon switching of the control.

The vehicle control part 21e is a program module that allows the control part 20 to perform a function of controlling the vehicle to travel along the recommended lane when the distance between the vehicle and the intersection is greater than or equal to the threshold value, and controlling the vehicle to travel the recommended region at the intersection when the distance between the vehicle and the intersection is less than the threshold value. Namely, the control part 20 determines a vehicle's control target and the amount of control based on a result of the determination by the determining part 21d, and controls each part of the vehicle with the amount of control.

Specifically, when the vehicle is controlled to travel along the recommended lane, the control part 20 detects section lines present on the left and right sides of a travel lane on which the vehicle travels, and performs control that allows the vehicle to travel in an area enclosed by the section lines, and thereby allows the vehicle to travel in the recommended lane. Namely, the control part 20 obtains the recommended lane obtained by the recommended lane obtaining part 21b, and identifies the types of section lines based on the navigation map information 30b.

A section line of a lane present at an edge of a road is a solid line, and a section line that separates lanes is a broken line. Therefore, for example, for a road with three lanes, a left section line of a left lane is a solid line, and a right section line of the left lane is a broken line. In addition, the left and right section lines of a center lane are both broken lines, and a right section line of a right lane is a solid line, and a left section line of the right lane is a broken line. Therefore, in such a road, a travel lane can be identified by identifying the modes of section lines present on the left and right sides of a lane on which the vehicle is traveling, or whether there is a left or right lane. In addition, for a road with four or more lanes, after identifying that an edge lane is a travel lane, a current travel lane can be identified based on the number of lane changes from the edge lane and lane change directions.

At any rate, the control part 20 identifies the types of section lines present on the left and right sides of the vehicle when the vehicle is traveling on the recommended lane. In addition, the control part 20 identifies section lines of lanes present around the vehicle, based on an output image from the camera 45. Then, when the section lines of the recommended lane are present on the left and right sides of the vehicle, the control part 20 performs control for lane keeping. Namely, when a distance between the vehicle and the left or right section line is greater than or equal to a preset distance, the control part 20 creates a target course that allows the vehicle to travel in the recommended lane (e.g., a course that allows the vehicle to travel parallel to the section lines), and sets the target course as a control target. In addition, when the distance between the vehicle and the left or right section line is less than the preset distance, the control part 20 creates a vehicle's target course for allowing the vehicle to move within the recommended lane so that the distance becomes greater than or equal to the preset distance, and sets the target course as a control target. Note that when a current travel lane is not the recommended lane, the control part 20 creates a target course that allows the vehicle to change the lane to the recommended lane, and sets the target course as a control target.

At any rate, when a control target is identified, the control part 20 identifies the amount of control for eliminating a difference between the target course and a current state. For example, the vehicle control ECU 44 obtains a current location of the vehicle based on output signals from the GNSS receiving part 41, the vehicle speed sensor 42, and the gyro sensor 43, and when there is a difference between the current location and the target course, the vehicle control ECU 44 creates a control course for the vehicle to move from the current location of the vehicle to the target course. Then, the control part 20 obtains the amount of control for the vehicle to move along the control course. Of course, the difference between the target course and the current state may be identified by other sensors, e.g., the camera 45 or a millimeter-wave radar, a laser radar, etc., which are not shown.

When the amount of control is obtained, the control part 20 outputs the amount of control to the vehicle control ECU 44. By the vehicle control ECU 44 controlling a control target based on the amount of control, the vehicle moves along the control course, and when the vehicle reaches the target course, the vehicle moves along the target course. Namely, the vehicle travels in an area of the recommended lane and travels along the planned travel route.

When the vehicle is controlled to travel the recommended region at the intersection, the control part 20 controls the vehicle based on the recommended region obtained by the function of the recommended region obtaining part 21c. The recommended region is a region that the vehicle is to travel at the intersection, and thus, the vehicle travels through the intersection by traveling along arbitrary locations in the recommended region, but in the present embodiment the control part 20 creates a vehicle's target course in the recommended region and sets the target course as a control target.

The target course is set at any location within the recommended region, and for example, the control part 20 sets a curve connecting the center of a lane that enters the intersection to the center of a lane that exits from the intersection, as a target course. Of course, this configuration is an example, and a configuration in which, for example, a curve connecting a front end of the vehicle to the center of a lane that exits from the intersection after entering the intersection is set as a target course, etc., may be adopted. Note that when there are a plurality of lanes entering the intersection or there are a plurality of lanes exiting from the intersection, setting targets for a target course are selected from the recommended lane, a lane on which the vehicle is traveling, etc. In addition, the curve may be identified by various techniques, and may be a Bezier curve, a clothoid curve, etc., or may be a path along which an arbitrary vehicle has traveled in the past, etc.

When a control target is identified, the control part 20 identifies the amount of control for eliminating a difference between the target course and a current state. For example, the vehicle control ECU 44 obtains a current location of the vehicle based on output signals from the GNSS receiving part 41, the vehicle speed sensor 42, and the gyro sensor 43, and when there is a difference between the current location and the target course, the vehicle control ECU 44 creates a control course for the vehicle to move from the current location of the vehicle to the target course. Then, the control part 20 obtains the amount of control for the vehicle to move along the control course. Of course, the difference between the target course and the current state may be identified by other sensors, e.g., the camera 45 or a millimeter-wave radar, a laser radar, etc., which are not shown.

When the amount of control is obtained, the control part 20 outputs the amount of control to the vehicle control ECU 44. By the vehicle control ECU 44 controlling a control target based on the amount of control, the vehicle moves along the control course, and when the vehicle reaches the target course, the vehicle moves along the target course. Namely, the vehicle travels in the recommended region and passes through the intersection.

In the navigation system 10 having the above-described configuration, the vehicle is controlled based on different pieces of information for when the distance to an intersection is greater than or equal to the threshold value and when the distance to the intersection is less than the threshold value (i.e., when the vehicle is far from the intersection and when the vehicle is near the intersection). Then, when the vehicle is far from the intersection, the vehicle is controlled to travel along a recommended lane, and when the vehicle is near the intersection, the vehicle is controlled to travel a recommended region at least at the intersection.

When the vehicle is controlled to travel along the recommended lane, it is not necessary to prepare in advance detailed information, e.g., information that can accurately identify a center location of a lane (the location (latitude/longitude) of the center of a lane measured by a measuring vehicle, etc.), as navigation map information 30b. In the present embodiment, lane-keeping control that allows the vehicle to travel within an area enclosed by section lines present on the left and right side of a travel lane is performed. In this control, vehicle control can be performed by identifying whether the vehicle is within the section lines. Therefore, when the vehicle is controlled to travel along the recommended lane, detailed information is not necessary as navigation map information 30b. Hence, according to the present embodiment, self-driving can be implemented using navigation map information 30b that can be easily prepared.

On the other hand, since there are no lanes at an intersection, in the present embodiment, recommended region information 30c about the intersection is generated, and the vehicle is controlled based on the recommended region information 30c. The recommended region information 30c is regions that the vehicle is to travel in the intersection, and can be generated without performing a task of, for example, accurately measuring courses along which the vehicle is to travel in the intersection. For example, in the present embodiment, the navigation system 10 can generate recommended region information 30c using the navigation map information 30b used for route guidance. According to the recommended region information 30c, the vehicle can be controlled to travel in the region, enabling to allow the vehicle to automatically travel through the intersection even if courses taken upon traveling through the intersection have not been accurately measured in advance. Therefore, according to the present embodiment, self-driving can be implemented using information that can be easily prepared and with the amount of information.

### (2) Vehicle Control Process

Next, a vehicle control process by the vehicle control program 21 will be described. FIG. 2 is a flowchart showing a vehicle control process performed by the control part 20 using the vehicle control program 21. When the user selects a destination by operating the user I/F part which is not shown, and instructs to search for a route, the control part 20 obtains a planned travel route based on the navigation map information 30b by the function of the planned travel route obtaining part 21a.

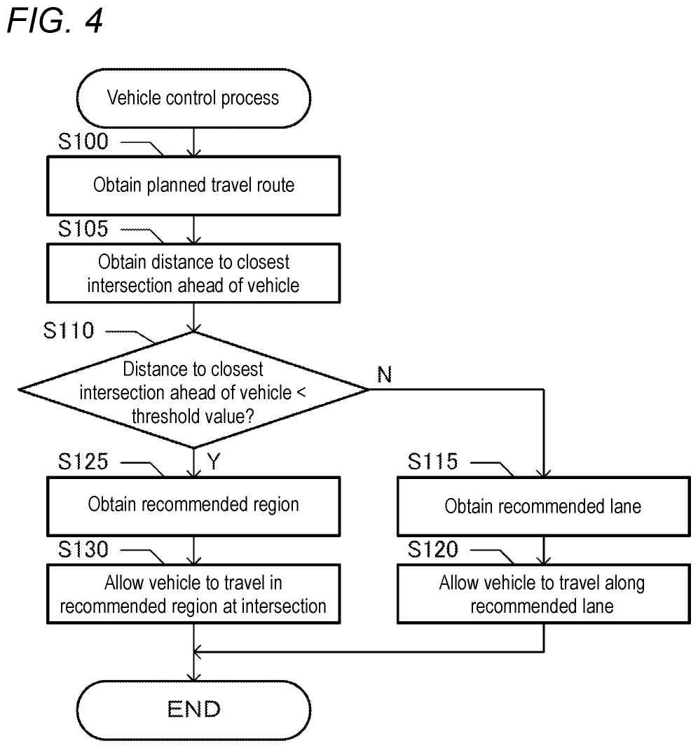

When the user instructs to start self-driving to the destination by operating the user OF part which is not shown with the planned travel route obtained, a vehicle control process shown in FIG. 4 starts every certain period (e.g., 100 ms). When the vehicle control process starts, the control part 20 obtains a planned travel route by the function of the planned travel route obtaining part 21a (step S100). Namely, the control part 20 obtains a current location of the vehicle, based on output signals from the GNSS receiving part 41, the vehicle speed sensor 42, and the gyro sensor 43. Then, the control part 20 obtains a planned travel route in a predetermined area ahead of the vehicle from the current location of the vehicle, from a pre-searched planned travel route.

Then, the control part 20 obtains a distance to the closest intersection ahead of the vehicle by the function of the determining part 21d (step S105). Namely, the control part 20 identifies the closest intersection present ahead of the current location of the vehicle by referring to the navigation map information 30b and the planned travel route. Then, a distance between the intersection and the current location of the vehicle is obtained.

Then, the control part 20 determines whether the distance to the closest intersection ahead of the vehicle is less than a threshold value (step S110). Namely, the control part 20 compares the distance obtained at step S105 with a predetermined threshold value.

If it is not determined at step S110 that the distance to the closest intersection ahead of the vehicle is less than a threshold value, the control part 20 obtains a recommended lane by the function of the recommended lane obtaining part 21b (step S115). Namely, the control part 20 identifies a traveling direction at the closest intersection ahead of the vehicle which is obtained at step S105. In addition, the control part 20 obtains, as a recommended lane, a lane on which the vehicle is to travel upon traveling in the traveling direction at the intersection, based on information indicating lane configurations included in the navigation map information 30b.

Then, the control part 20 allows the vehicle to travel along the recommended lane by the function of the vehicle control part 21e (step S120). Namely, the control part 20 creates a target course that allows the vehicle to travel in the recommended lane by referring to the navigation map information 30b, and creates a control course for allowing the vehicle to travel along the target course. Then, the control part 20 obtains the amount of control based on a difference between the target course and the control course, and outputs the amount of control to the vehicle control ECU 44. As a result, the vehicle control ECU 44 controls a control target to allow the vehicle to travel along the recommended lane.

If it is determined at step S110 that the distance to the closest intersection ahead of the vehicle is less than a threshold value, the control part 20 obtains a recommended region by the function of the recommended region obtaining part 21c (step S125). Namely, the control part 20 obtains recommended region information 30c for allowing the vehicle to travel in the traveling direction at the closest intersection ahead of the vehicle which is obtained at step S105.

Then, the control part 20 allows the vehicle to travel in the recommended region at the intersection by the function of the vehicle control part 21e (step S130). Namely, the control part 20 creates a target course that allows the vehicle to travel in the recommended region obtained at step S125, and creates a control course for allowing the vehicle to travel along the target course. Then, the control part 20 obtains the amount of control based on a difference between the target course and the control course, and outputs the amount of control to the vehicle control ECU 44. As a result, the vehicle control ECU 44 controls a control target to allow the vehicle to travel in the recommended region and pass through the intersection. Note that when the processes at and after step S125 are performed just before the intersection, step S115 and S120 may be performed with step S125 and S130, or control at step S115 and S120 may be gradually switched to control at step S125 and S130.

### (3) Other Embodiments

The above-described embodiment is an example for implementing the present disclosure, and other various embodiments can also be adopted as long as information used to control the vehicle is changed based on the positional relationship with an intersection. For example, the vehicle control system may be implemented by other devices than the navigation system 10, e.g., the vehicle control ECU 44. In addition, the vehicle control system may be a device mounted on the vehicle, etc., or may be a device implemented by a portable terminal, or may be a system implemented by a plurality of devices (e.g., a client and a server).

In addition, at least some of the planned travel route obtaining part 21a, the recommended lane obtaining part 21b, the recommended region obtaining part 21c, the determining part 21d, and the vehicle control part 21e may be separately present in a plurality of devices. For example, a configuration in which by the navigation system making a request to a server through communication, a search for a planned travel route, identification of a recommended lane, identification of a recommended region, determination of the type of control, identification of a target course, identification of a control course, identification of the amount of control, etc., are performed by the server and transmitted, as a response, to the vehicle control system, etc., may be adopted. Of course, a part of the configuration of the above-described embodiment may be omitted, or the order of processes may be changed or omitted.

The planned travel route obtaining part may be configured in any manner as long as a vehicle's planned travel route can be obtained. The planned travel route may be a route obtained by searching for a route from a point of departure to a destination as described above, or may be, for example, a planned travel route estimated from the past travel history, etc., and may be obtained by various techniques.

The recommended lane obtaining part may be configured in any manner as long as a recommended lane on which the vehicle is to travel can be obtained. Namely, in order to travel along a planned travel route, it may be preferred to select a specific lane or avoid a specific lane. Hence, the recommended lane obtaining part may be configured in any manner as long as a lane to be recommended can be obtained as a recommended lane in order to avoid a situation in which traveling along the planned travel route becomes impossible (a detour or a sudden lane change becomes necessary).

In addition, when there are a plurality of lanes that can enter an intersection, there may be a rule that in order to exit in a specific direction, the vehicle needs to enter the intersection from a specific lane. Therefore, a situation can occur in which in order to exit in a specific direction from an intersection to travel along a planned travel route, the vehicle needs to enter the intersection using a specific lane. In such a case, the specific lane is a recommended lane. Note that when a trouble has occurred in a specific lane, e.g., when a specific lane on a road is under construction or closed, a lane different than the specific lane may serve as a recommended lane.

The recommended region obtaining part may be configured in any manner as long as a recommended region that the vehicle is to travel in an intersection included in a planned travel route can be obtained based on the planned travel route. Namely, in conventional map information such as typical map information used in the navigation system, regions that the vehicle is to travel in an intersection have not been defined. Hence, when a recommended region is obtained by the recommended region obtaining part, a control target in an intersection is provided, and thus, it becomes possible to easily perform vehicle control in the intersection, based on simple information.

In addition, the conventional technique has adopted a configuration in which, for example, upon setting a vehicle's course in an intersection as a control target, an accurate course in linear shape (also including a line made up of a plurality of points) which is measured by a measuring vehicle is defined in advance. However, vehicle behavior expected for the vehicle at the intersection is not limited to behavior in which the vehicle traces on a single line, and has arbitrariness, and in most cases, the vehicle may travel a wider area than a course on a line. Therefore, by a recommended region being defined as a region having an area, it is possible to more simplify vehicle control in the intersection. The recommended region may be configured in any manner as long as the recommended region is a figure having an area instead of a narrow area like a line.

Furthermore, the recommended region is a region that the vehicle is to travel in an intersection, and the region can vary depending on a combination of a vehicle's entry direction to the intersection and a vehicle's exit direction from the intersection. For example, a region that the vehicle travels can vary between when the vehicle enters an intersection from a given road and makes a right turn and when the vehicle makes a left turn. Therefore, it is preferred that a recommended region be obtained based on vehicle's entry and exit directions at an intersection.

Of course, a recommended lane may be defined in advance, recorded in a recording medium of the navigation system or a server that can communicate with the navigation system, and referred to, or may be created as the need arises. In addition, a recommended region of the above-described embodiment is an example, and a single recommended region is associated with a traveling direction at an intersection, but other configurations may be adopted. For example, when there are a plurality of lanes that can enter an intersection, a recommended region may be defined for each of the lanes. In addition, when there are a plurality of lanes that can exit from the intersection, a recommended region may be defined for each of the lanes. Furthermore, the number of lanes that can enter the intersection and the number of lanes that can exit from the intersection may match each other (e.g., FIG. 3A) or may differ from each other (e.g., FIG. 3B). When there are a plurality of lanes that can enter the intersection, a plurality of recommended regions each having one lane that can enter the intersection and having a plurality of lanes that can exit from the intersection may be set.

Furthermore, a recommended region may be created from the navigation map information 30b as in the above-described embodiment, or may be created based on other information. For example, a recommended region may be identified based on travel paths obtained when a plurality of probe vehicles have traveled through an intersection. Namely, by a server collecting vehicles' paths from probe vehicles and creating a region including paths along which a plurality of vehicles have traveled in an intersection, recommended region information 30c for the intersection can be generated.

Then, by adopting a configuration in which recommended region information 30c generated by the server is recorded in advance in the recording medium 30 of the navigation system 10, or recommended region information 30c is received by a communication part from the server and recorded in the recording medium 30, it is possible to perform control based on a recommended region created based on probe information. According to the above-described configuration, the vehicle does not need to be measured at an intersection by a special vehicle, etc., that can measure a location with high accuracy, and recommended region information 30c can be generated using an already widespread mechanism, and thus, the recommended region information 30c can be easily generated.

The vehicle control part may be configured in any manner as long as the vehicle control part can control the vehicle to travel along a recommended lane when a distance between the vehicle and an intersection is greater than or equal to the threshold value, and can control the vehicle to travel a recommended region at the intersection when the distance between the vehicle and the intersection is less than the threshold value. Namely, the vehicle control part may be configured in any manner as long as the vehicle control part can switch information to be referred to upon vehicle control, based on a current location of the vehicle. There are no lanes (in most cases) at intersections and there are lanes (in most cases) on roads other than the intersections. Therefore, the vehicle control part may be configured in any manner as long as the vehicle control part can switch whether to refer to a recommended region which is information for an intersection or refer to a recommended lane which is information for a non-intersection, based on a distance between an intersection and the vehicle.

The determining part may be configured in any manner as long as the determining part can determine whether to perform vehicle control using a recommended region, based on a positional relationship between the vehicle and an intersection, and the positional relationship is identified based on a distance between the vehicle and the intersection. The distance may be evaluated by a distance value between a current location of the vehicle and the location of the intersection, or may be evaluated by other information, e.g., whether the size of an image of the intersection measured by a camera or a sensor is a specific size, and various configurations can be adopted.

Note that control performed simultaneously is not limited to one type, and control that allows the vehicle to travel along a recommended lane and another control, e.g., control for avoiding vehicles around the vehicle, may be performed. Furthermore, control that allows the vehicle to travel in a recommended region and another control, e.g., control that monitors the state of a traffic light, may be performed.

Control that allows the vehicle to travel along a recommended lane may be any control as long as the vehicle can be controlled to travel along a planned travel route by the vehicle traveling the recommended lane. Therefore, various control may be performed in addition to control that allows the vehicle to travel in an area enclosed by section lines present on the left and right sides of a travel lane. For example, a configuration in which section lines on both sides of a recommended lane are detected by a camera, a sensor etc., and the vehicle is controlled to trace a course passing through a specific location (the center, etc.) for the section lines, etc., may be adopted.

Control that allows the vehicle to travel in a recommended region may be any control as long as the vehicle can be controlled to travel along a planned travel route by the vehicle traveling in the recommended region. Therefore, various control may be performed as long as the vehicle can be controlled to enter an intersection, travel in a recommended region, and exit from the intersection.

Furthermore, a technique for changing information to be used for vehicle control, based on the positional relationship with an intersection as in the present disclosure can also be applied as a program and a method. In addition, a system, a program, and a method such as those described above can be assumed to be implemented as a single device or implemented by a plurality of devices, and include various types of modes. For example, it is possible to provide a navigation system, a method, and a program that include means such as those described above. In addition, changes can be made as appropriate, e.g., a part is software and a part is hardware. Furthermore, it is also feasible to provide a recording medium for a program that controls the system. Of course, the recording medium for software may be a magnetic recording medium or a semiconductor memory, and any recording medium to be developed in the future can also be considered exactly in the same manner.

### REFERENCE SIGNS LIST

10: Navigation system, 20: Control part, 21: Vehicle control program, 21a: Planned travel route obtaining part, 21b: Recommended lane obtaining part, 21c: Recommended region obtaining part, 21d: Determining part, 21e: Vehicle control part, 30: Recording medium, 30a: Map information, 30b: Navigation map information, 30c: Recommended region information, 41: GNSS receiving part, 42: Vehicle speed sensor, 43: Gyro sensor, 44: Vehicle control ECU, and 45: Camera

1. A vehicle control system comprising:
a planned travel route obtaining part that obtains a planned travel route of a vehicle;
a recommended lane obtaining part that obtains a recommended lane on which the vehicle is to travel, based on the planned travel route;
a recommended region obtaining part that obtains a recommended region that the vehicle is to travel in an intersection included in the planned travel route, based on the planned travel route; and
a vehicle control part that controls the vehicle to travel along the recommended lane when a distance between the vehicle and the intersection is greater than or equal to a threshold value, and controls the vehicle to travel the recommended region at the intersection when the distance between the vehicle and the intersection is less than the threshold value.

2. The vehicle control system according to claim 1, further comprising a determining part that determines whether to perform control of the vehicle using the recommended region, based on a positional relationship between the vehicle and the intersection.

3. The vehicle control system according to claim 1, wherein the recommended region is identified as a region based on map information including link data representing, for each traveling direction, a road connection relationship and lane data representing lanes present on roads, the region connecting the lane that can enter the intersection to the lane that can exit from the intersection.

4. The vehicle control system according to any one of claim 1, wherein the recommended region is identified based on travel paths obtained when a plurality of probe vehicles have traveled through the intersection.

5. The vehicle control system according to any one of claim 1, wherein the control that allows the vehicle to travel along the recommended lane is control that detects section lines present on a left and a right side of a travel lane on which the vehicle travels, and allows the vehicle to travel in an area enclosed by the section lines.

6. A vehicle control system comprising:
a planned travel route obtaining part that obtains a planned travel route of a vehicle;
a recommended region obtaining part that obtains a recommended region that the vehicle is to travel in an intersection included in the planned travel route, based on the planned travel route; and
a vehicle control part that controls the vehicle to travel the recommended region at the intersection.

7. A vehicle control program that causes a computer to function as:
a planned travel route obtaining part that obtains a planned travel route of a vehicle;
a recommended lane obtaining part that obtains a recommended lane on which the vehicle is to travel, based on the planned travel route;
a recommended region obtaining part that obtains a recommended region that the vehicle is to travel in an intersection included in the planned travel route, based on the planned travel route; and
a vehicle control part that controls the vehicle to travel along the recommended lane when a distance between the vehicle and the intersection is greater than or equal to a threshold value, and controls the vehicle to travel the recommended region at the intersection when the distance between the vehicle and the intersection is less than the threshold value.

8. A non-transitory computer readable medium storing a vehicle control program that causes a computer to function as:
a planned travel route obtaining part that obtains a planned travel route of a vehicle;
a recommended region obtaining part that obtains a recommended region that the vehicle is to travel in an intersection included in the planned travel route, based on the planned travel route; and
a vehicle control part that controls the vehicle to travel the recommended region at the intersection.
